(19) United States
(12) Patent Application Publication
(10) Pub. No.: US 2017/0102303 A1
(43) Pub. Date: Apr. 13, 2017

(54) Method of Calculating Potential Sliding Face Progressive Failure of Slope

(71) Applicant: Hubei University of Technology, Wuhan (CN)

(72) Inventors: Ying-Fa LU, Wuhan (CN); De-Fu LIU, Wuhan (CN)

(21) Appl. No.: 15/048,781

(22) Filed: Feb. 19, 2016

(30) Foreign Application Priority Data
Oct. 12, 2015 (CN) 201510658880.6

(51) Int. Cl. G01N 3/24

(52) U.S. Cl. CPC G01N 3/24

(57) ABSTRACT

A method of calculating the potential sliding surface of the progressive failure of slope is provided, which is also abbreviated as a failure angle rotation method. The method performs the search calculation of the potential sliding surface of the slope to determine the potential sliding surface, under the assumption that the geological material failure satisfies the condition of the angle between the maximum shear stress surface and the minimum principal stress axis corresponding to the critical stress state being (45° +φ/2), and based on the fact that the principal stress directions at different positions are rotated while the slope is applied different external loads and gravity loads. The failure path is varied with the change of the stress during the failure process to perform the solution for the potential sliding surface of the slope based on numerical calculation.

### CROSS-REFERENCE TO RELATED APPLICATION

This application claims the benefit of China Patent Application No.

201510658880.6, filed on Oct. 12, 2015, in the State Intellectual Property Office of the People's Republic of China, the disclosure of which is incorporated herein in its entirety by reference.

### BACKGROUND OF THE INVENTION

1. Field of the Invention

The present invention relates to prevention, evaluation, forecast and pre-warning for civil engineering, geological disaster or foundation, more particularly to field of establishing stability analysis, evaluation, forecast, warning, and prevention measures for geological disaster or foundation. The present invention achieves the determination and stability evaluation of the potential sliding face of progressive failure process in the geological disaster or foundation, and provides great promoting functions in prevention, forecast and warning for the slope or foundation.

2. Description of the Related Art

A stability evaluation of a slope is established on a prerequisite of limit equilibrium status, and currently there are several stability calculation methods widely adopted including Swedish method, the simplified Bishop method, Janbu method, the transfer coefficient method, Sarma method, the wedge method, Fellenius method, or the finite element strength reduction method. The determination of the potential sliding surface is also established based on the critical stress state theory. However, the slope failure in situ is progressive, the failure of the sliding surface is situated in critical stress status, and other part may be situated in a state after failure or before peak stress state. The potential sliding surface obtained by the conventional limit equilibrium state method is hard to be consistent with that in situ. To solve the problem, the present invention provides a method of calculating the potential sliding surface of the progressive failure of slope (hereinafter referred to define as a failure angle rotation method), and this method greatly promotes the determination of potential sliding surface in situ.

### SUMMARY OF THE INVENTION

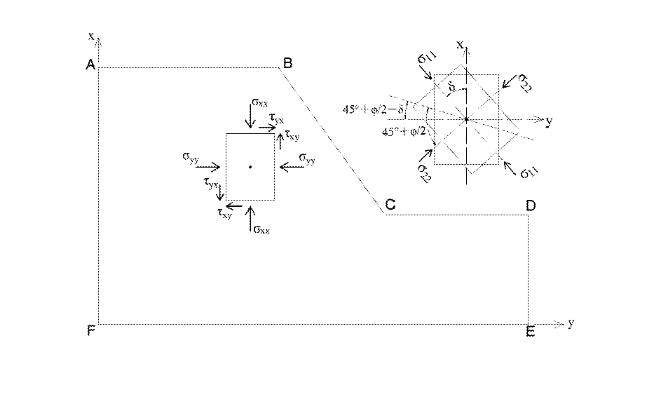

An objective of the present invention is to provide a method of calculating a potential sliding surface of the progressive failure of slope on a basis that the slope failure is progressive, the principal stress axis of the slope failure is rotatable but the failure angle on the maximum shear surface is constant with respect to the minimum principal stress, so as to obtain the rotation regularity of the failure angle for performing search calculation for the potential sliding surface of slope, to further determine the potential sliding surface (as shown in FIG. 1). The method of the present invention also defines concepts of a failure ration and a failure percentage. The failure ratio is an absolute value of the division of a sliding shear stress (or tension stress) on the sliding surface by the critical friction stress (or critical tension stress) on the sliding surface by a landslip bed, and the failure ratio is set as 100% when the absolute value of the division is higher than 100%. The failure percentage is a division of a sum of products of the possible sliding surface area and the failure ratio, by the total area. The failure angle rotation method of the present invention can guarantee that the stress state of the failure point is situated in the critical stress state during the process of a slope failure. In addition, the failure path is varied with the change of the stress during the failure process, so the method combines the concepts of the failure ratio and the failure percentage and considers the softening characteristic under different normal stresses in the constitutive relation, to perform the solution for the potential sliding surface of the slope based on numerical calculation.

The present invention provides a method of calculating potential sliding surface of progressive failure of slope. The method includes following steps:

(1) Performing an shear stress-shear strain complete process curve experiment for the geological material of slope, to obtain a peak stress, a peak strain and a complete process curve;

(2) Determining a cohesion C and a sliding-surface friction angle value φ by the peak stress, determining magnitudes of constant coefficients a₁, a₂, a₃ by the peak strain, and determining a shear modulus G, a critical normal stress σₙ^{crit} and constant coefficients ξ, α, kₙ by variation curve characteristics;

(3) Establishing a numerical calculation model with consideration of shear failure distribution and tension failure distribution area;

(4) Based on numerical calculation of a strain softening constitutive model, calculating failure ratio, failure percentage and failure area percentage at different points and entire sliding face of the current slope, so as to provide different possible failure paths by a combination manner;

(5) For each of critical state elements of the slope, according to an angle between a shear stress surface of unit failure and the minimum principal stress being 45°+φ/2, calculating a rotating angle δ of the maximum principal stress with respect to a vertical direction, so as to determine a rotating angle βᵢᵢ=45°+φ/2−δᵢᵢ of the sliding surface with respect to a horizontal surface, wherein the rotating angle δ is calculated by a two-dimensional equation tan 2δ=−2τ_{xy}/(φₓₓ−φ_{yy}) or by a three-dimensional equation tan 2φₓₓ=−2τ_{xy}/(φₓₓ−φ_{yy}), tan 2δ_{yy}=−2τ_{zy}/(φ_{yy} −φ_{zz}), tan 2δ_{zz}=−2τ_{zx}/φ_{zz}−φₓₓ);

(6) As to possibly applied load or displacement boundary condition, stepwise applying corresponding to boundary condition and searching possible failure mode under different boundary conditions, and performing potential sliding surface rotating angle continuation and calculating a stability factor of the corresponding slope, so as to determine the potential sliding surface.

(7) Preferably, a sliding surface shear stress-shear strain with softening and hardening mechanical characteristics is employed:

(7.1) Shear Stress-Shear Strain Equation

Shear stress-shear strain is a four-parameter constitutive equation:

τ=Gγ[l+γ^{q}/p]^{ξ} (7.1)

where τ, γ are shear stress and shear strain respectively, G is shear modulus, p, q, ξ are constant coefficients under different normal stresses, and τ, G in a unit of MPa, kPa or Pa, p, q, ξ are parameters with no unit, and softening and hardening behaviors are described below.

(7.2) Softening Characteristics

As to the material behavior with softening characteristic, −1<τ≦0 and 1+qτ≠0; the critical strain satisfies a relation:

P+(1±qτ)γ^{q}ₚₑₐₖ=0 (7.2)

where γₚₑₐₖ is the strain corresponding to the critical stress.

It is assumed that the critical stress τₚₑₐₖ satisfies the Mohr-Coulomb Criteria (alternatively, the critical stress τₚₑₐₖ can also satisfies other related criteria):

τₚₑₐₖ=C+φₙtan φ (7.3)

where C is cohesion, φₙ is normal stress, C and φₙ are in a unit of MPa, kPa or Pa, and φ is sliding-surface friction angle.

It is assumed that the critical strain is only correlated with the normal stress, and the critical strain γₚₑₐₖ has a relation:

(γₚₑₐₖ/a₃)²+((φₙ−a₂)/a₁)^{ζn}=1 (7.4.1)

or γₚₑₐₖ²=a₁⁰+a₂⁰φₙ+a₃⁰φₙ² (7.4.2)

where a₁, a₂, a₃, ζ_{N}, a₁⁰, a₂⁰, a₃⁰ are constant coefficients, a₁, a₂ are in the unit of MPa, kPa or Pa, a₃, ζₙ are dimensionless coefficients, or a₂⁰, a₃⁰ are in a dimension of 1/MPa, 1/MPa², 1/kPa, 1/kPa² or 1/Pa,1 /Pa²,

and G=G₀+b₁φₙ+b₂φₙ² (7.5)

where G₀ is that value that the normal stress φₙ is equal to zero, b₁, b₂ are constant coefficients, and dimensionless or in a dimension of 1/MPa, 1/kPa or 1/Pa.

For the dimensionless ξ, the softening factor evolution equation is:

ξ=ξ₀/(1+(ξ₀/ξ_{c}−1)(φₙ/φₙ^{c})^{ζ}) (7.6)

where ξₒ is the value when normal stress (φₙ) is equal to zero, ξ, is the value that φₙ is equal to φₙ^{c}, and ζ is a constant coefficient.

(7.3) Hardening Characteristic

When the normal stress of the geological material is higher than a critical normal stress φₙ^{crit}, there is no obvious peak stress, so two calculation methods are invented.

(7.3.1) First Calculation Method

The first calculation method includes following steps:

Substituting ξ=−1 and q=1 into the constitutive Equation(7.1), to obtain a′=1/(Ga″) and b′=1/(Gp), and the equation form is identical with the Duncan-Chang model and only describes elastic-plastic hardening behavior characteristics of the material:

$$τ = \frac{γ}{{a}^{′} + {b}^{′} γ} \qquad ( 7.7 )$$

where a′, b′, a″ are constant coefficients;

under a condition of stress at peak, the Equation (7.7) becomes:

$${a}^{′} + {b}^{′} {γ}_{peak} = \frac{1}{{τ}_{peak} / {γ}_{peak}} \qquad ( 7.8 )$$

Defining a secant modulus

$$\begin{matrix}{k}_{scant} = \frac{{τ}_{peak}}{{γ}_{peak}} and & ( 7.9 ) \\ {a}^{′} + {b}^{′} {γ}_{peak} = \frac{1}{{K}_{cant}} & ( 7.10 )\end{matrix}$$

Finding derivative of equation (7.7), the corresponding derivative is a tangent modulus, and under any stress state condition, the tangent modulus Gᵢ is expressed as:

$${G}_{i} = \frac{{a}^{′}}{{( {a}^{′} + {b}^{′} γ )}^{2}} \qquad ( 7.11 )$$

Applying the Equation (7.11) to obtain the tangent modulus Gₜ under the maximum stress:

Gᵢ=a′K_{cant}² (7.12)

As we all know, the conventional experiment is hard to obtain the peak stress for a plastic hardening behavior without obvious peak stress, the selection of the peak stress must satisfy various stress criteria (such as Mohr-Coulomb Criteria), and the corresponding shear strain also satisfies the strain space equation provided by the present invention. Under the condition of the stress at peak, researching the tangent modulus Gₜ of the curve of the experiment, and assuming that the tangent modulus Gₜ has characteristics below:

Gₜ=α(φₙ−φₙ^{crit})(φₙ/φₙ^{crit})^{k} (7.13)

φₙ^{crit}≦φₙ≦φₙ^{max}, and α, kₙ are constant coefficients.

The Equation (7.13) has Features Below.

When φₙ=φₙ^{crit}, the tangent modulus is equal to zero and the curve shows characteristics of the approximately perfect elasto-plastic model. When φₙ reaches a constant value φₙ^{max}, the curve shows linear characteristics theoretically, the normal stress is determined by the experiment, φₙ=φₙ^{max} and corresponding tangent modulus is G^{max}, and an equation is expressed as:

α(φₙ^{max}−φₙ^{crit})(φₙ^{max}/φₙ^{crit})^{k}^{ₙ}=G^{max} (7.14)

The first calculation method further includes steps in a range of the normal stress (φₙ^{crit}, φₙ^{max}], selecting a normal stress φₙ^{a} and performing an experiment to determine a corresponding tangent modulus G^{a}, to obtain the equation below:

α(φₙ^{a}−φₙ^{crit})(φₙ^{a}/φₙ^{crit})^{k}^{ₙ}=G^{a} (7.15)

Determining constant coefficients by equations (7.14 and 7.15):

$${k}_{n} = \frac{ln ( {G}^{max} ( {σ}_{n}^{α} - {σ}_{n}^{crit} ) / ( {G}^{a} ( {σ}_{n}^{max} - {σ}_{n}^{crit} ) )}{ln ( {σ}_{n}^{max} / {σ}_{n}^{α} )} and α = {G}^{max} / ( ( {σ}_{n}^{max} - {σ}_{n}^{crit} ) {( {σ}_{n}^{max} / {σ}_{n}^{crit} )}^{{k}_{n}} ) \qquad ( 7.16 )$$

After the tangent modulus Gₜ of the peak stress under a condition of a specific normal stress is determined, a′ is determined by Equation (7.12) and b′ is determined by the Equation (7.10), so as to determine all parameters of a new Duncan-Chang model.

(7.3.2) Second Calculation Method

The second calculation method includes following steps:

Substituting ξ=−1 into the constitutive Equation (7.1) to express the Equation (7.17):

$$τ = \frac{G γ}{1 + {γ}^{q} / p} \qquad ( 7.17 )$$

under the peak stress:

$$\begin{matrix}{τ}^{peak} / {γ}_{peak} = \frac{G}{1 + {( {γ}_{peak} )}^{q} / p} & ( 7.18 ) \\ {γ}_{peak}^{q} / p = \frac{G}{{K}_{scant}} - 1 & ( 7.19 )\end{matrix}$$

Similarly, finding derivative of the Equation (7.17), wherein the obtained derivative is a tangent modulus:

$$\frac{\partial τ}{\partial γ} = \frac{G}{( 1 + {γ}^{q} / p )} - \frac{Gq {γ}^{q} / p}{{( 1 + {γ}^{q} / p )}^{2}} \qquad ( 7.20 )$$

when the peak stress satisfies the current Mohr-Coulomb Criteria, the peak strain also satisfies the equation (7.4), and the tangent modulus is Gₜ under the peak stress;
according to equations (7.18 and 7.19), under the peak stress, the tangent modulus satisfies an equation (7.21):

$${G}_{t} = {K}_{scant} [ 1 + \frac{{qK}_{scant}}{G} ( 1 - \frac{G}{{K}_{scant}} ) ] \qquad ( 7.21 )$$

Solving the tangent modulus corresponding to the peak stress according to the Equation (7.13), solving parameter q according to the Equation (7.21), and solving parameter P according to the Equation (7.19).

(8) For the slice method widely applied, the determination of the potential sliding surface by the failure angle rotation method includes following sub-steps:

(8.1) Conducting a Compartment Division on the Slope;

(8.2) Calculating a vertical stress by product of a gravity and a height, and calculating a horizontal stress and shear stress by vector components of an unbalance thrust in horizontal direction and a shear stress from the vertical to the horizontal direction, wherein it is assumed that the vector component in the horizontal direction and the vector component in the vertical direction satisfy a specific stress distribution condition (such as linear distribution or parabolic curve distribution);

(8.3) calculating a friction stress on a bottom of a compartment according to the step (7).

(9)The conditions of determination of the potential sliding surface can be divided into two cases for numerical calculation:

(9.1) Numerical Calculation

The potential sliding surface is determined by the numerical calculation, and the determination is conducted by stepwise applying the conventional strength reduction method and the possible-load (or displacement) boundary condition method.

(9.1.1) Conventional Strength Reduction Method

Based on the failure angle rotation method provided by the present invention, the critical anti-shearing strength is reduced until the failure compartment located on a free surface is situated in a limit equilibrium state.

(9.1.2) Load (or Displacement) Boundary Condition Method

Based on the failure angle rotation method of the present invention, the corresponding load or displacement working condition is applied on the possible failure until the failure compartment located on a free surface is situated in a limit equilibrium state.

(9.2) Slice Method

The determination of the potential sliding surface by the slice method is conducted by conventional strength reduction and the load (or displacement) boundary condition applying method.

(9.2.1) Conventional Strength Reduction Method

Based on the failure angle rotation method of the present invention, the critical anti-shearing strength on the bottom of the compartment is reduced until the failure compartment located on the last slice block is situated in a limit equilibrium state.

(9.2.2) Load (or Displacement) Boundary Condition Method

Based on the failure angle rotation method of the present invention, the corresponding load or displacement boundary condition is applied on the possible failure until the failure compartment located on a free surface is situated in a limit equilibrium state.

In the two methods, calculation of the strength reduction method does not have physical meaning, so the obtained stress and displacement by calculation of the strength reduction method cannot be compared with that in situ, logically.

The method of calculating the potential sliding surface of the progressive failure of slope for the present invention has at least one of following advantages.

The conventional method of determining the potential sliding surface of the slope mainly adopts the limit state search method (such as Swedish circle method) to determine the potential sliding surface, based on mechanics parameters (such as cohesion C or friction angle) under the limit equilibrium state. The method of determining the potential sliding surface has following drawbacks. Firstly, whole sliding surface is situated in the critical stress state, but the sliding surface failure of the slope is progressive. Secondly, during slope failure, the failure point is situated in the critical stress status, and other part of the slope is situated in the status after failure or before peak stress state, but this failure is hard to be described by the conventional method.

To solve these drawbacks, the method of the present invention performs the search calculation to determine the potential sliding surface of slope, under the assumption that the geological material failure satisfies the condition of the angle between the maximum shear stress surface and the minimum principal stress axis corresponding to the critical stress state being (45′+φ/2), and based on the fact that the principal stress directions at different positions are rotated (that is the rotating angle δ) while the slope is applied different external loads and gravity loads. The method also defines the concepts of the failure ratio and the failure percentage and provides the load or displacement boundary condition method. The failure angle rotation method of the present invention can guarantee that the stress state of the failure point is situated in the critical stress state during the process of a slope failure. In addition, the failure path is varied with the change of the stress during the failure process, so the method combines the concepts of the failure ratio and the failure percentage and considers the softening characteristic under different normal stresses of the failure path, to perform the solution for the potential sliding surface of the slope based on numerical calculation.

### BRIEF DESCRIPTION OF THE DRAWINGS

The detailed structure, operating principle and effects of the present disclosure will now be described in more details hereinafter with reference to the accompanying drawings that show various embodiments of the present disclosure as follows.

The figure is a schematic view of the method of determining the failure angle rotation of the potential sliding surface of the progressive failure of slope, where φₓₓ [symbol] φ_{yy}, τ_{xy}, φ, φ₁₁, φ₂₂, δ are the stresses in X-axis, in Y-axis direction, a shear stress, a friction angle, the maximum principal and minimum principal stress, and the rotating angle, respectively.

### DETAILED DESCRIPTION OF THE PREFERRED EMBODIMENTS

Reference will now be made in detail to the exemplary embodiments of the present disclosure, examples of which are illustrated in the accompanying drawings. Therefore, it is to be understood that the foregoing is illustrative of exemplary embodiments and is not to be construed as limited to the specific embodiments disclosed, and that modifications to the disclosed exemplary embodiments, as well as other exemplary embodiments, are intended to be included within the scope of the appended claims. These embodiments are provided so that this disclosure will be thorough and complete, and will fully convey the inventive concept to those skilled in the art. The relative proportions and ratios of elements in the drawings may be exaggerated or diminished in size for the sake of clarity and convenience in the drawings, and such arbitrary proportions are only illustrative and not limiting in any way. The same reference numbers are used in the drawings and the description to refer to the same or like parts.

It will be understood that, although the terms ‘first’, ‘second’, ‘third’, etc., may be used herein to describe various elements, these elements should not be limited by these terms. The terms are used only for the purpose of distinguishing one component from another component. Thus, a first element discussed below could be termed a second element without departing from the teachings of embodiments. As used herein, the term “or” includes any and all combinations of one or more of the associated listed items.

Please refer to the figure which shows a method of calculating potential sliding surface of the progressive failure of slope, in accordance with the present invention. The method includes following steps:

(1) Performing an shear stress-shear strain complete process curve experiment on a sliding body material, to obtain a peak stress, a peak strain and a complete process curve;

(2) Determining a cohesion C and a sliding-surface friction angle value φ by the peak stress, determining magnitudes of constant coefficients a₁, a₂, a₃ by the peak strain, and determining a shear modulus G, a critical normal stress φₙ^{crit} and constant coefficients ξ, α, kₙ by variation curve characteristics;

(3) Establishing a numerical calculation model with consideration of shear failure distribution and tension failure distribution area;

(4) Based on numerical calculation of a strain softening constitutive model, calculating failure ratio, failure percentage and failure area percentage at different points of the current slope, so as to provide different possible failure paths by a combination manner;

(5) For each element of the slope, according to an angle between a shear stress surface of element failure and the minimum principal stress being 45°+φ/2, calculating a rotating angle δ of the maximum principal stress with respect to a vertical direction, so as to determine a rotating angle βᵢᵢ=56°+φ/2 −δᵢᵢ of the sliding surface with respect to a horizontal surface, wherein the rotating angle δ is calculated by a two-dimensional equation tan 2δ=−2τ_{xy}/(φₓₓ−φ_{yy}) or by a three-dimensional equation tan 2δₓₓ=−2τ_{xy}/(φₓₓ−φ_{yy}), tan 2δ_{yy}=−2τ_{zy}/(φ_{yy}−φ_{zz}), tan 2δ_{zz} =−2τ_{zx}/(φ_{zz}−φ_{zz});

(6) As to possibly applied load or displacement boundary condition, stepwise applying corresponding boundary condition and searching possible failure mode under different boundary conditions, and performing potential sliding surface rotating angle continuation and calculating a stability factor of the corresponding slope, to determine the potential sliding surface.

(7) A sliding surface shear stress-shear strain with softening and hardening mechanical characteristics is employed preferably:

(7.1) Shear Stress-Shear Strain Equation

The shear stress-shear strain is a four-parameter constitutive equation:

τ=Gγ[1+γ^{q}/p]^{ξ} (7.1)

where τ, γ are shear stress and shear strain respectively, G is shear modulus, p, q, ξ are constant coefficients under different normal stresses, and τ, G in a unit of MPa, kPa or Pa, p, q, ξ are parameters with no unit, and softening and hardening behaviors are described below.

(7.2) Softening Characteristics

As to the material behavior having softening characteristic, −1<ξ≦0 and 1+qξ≠0 ;the critical strain satisfies a relation:

p+(1+qξ)γ^{q}ₚₑₐₖ=0 (7.2)

where γₚₑₐₖ is the strain corresponding to the critical stress.

It is assumed that the critical stress space ξₚₑₐₖ satisfies the Mohr-Coulomb Criteria (alternatively, the critical stress space ξₚₑₐₖ can also satisfies other related criteria):

τₚₑₐₖ=C+φₙ tan φ (7.3)

where C is cohesion, φₙ is normal stress, C and φₙ are in a unit of MPa, kPa or Pa, φ is sliding-surface friction angle;

It is assumed that the critical strain is only correlated with the normal stress, and the critical strain γₚₑₐₖ has a relation:

(γₚₑₐₖ/a₃)²+((φₙ−a₂)/a₁)^{ξN}=1 (7.4.1)

or γₚₑₐₖ²=a₁⁰+a₂⁰φₙ+a₃⁰φₙ² (7.4.2)

where a₁, a₂, a₃, ζ_{N}, a₁⁰, a₂⁰, a₃⁰ are constant coefficients, a₁, a₂ are in the unit of MPa, kPa or Pa, a₃, ζ_{N} are dimensionless coefficients, or a₂⁰, a₃⁰ are in a dimension of 1/MPa, 0/MPa², 1kPa ,1/kPa² or 1/Pa, 1/Pa²;

and G=G₀+b₁φₙ+b₂φₙ² (7.5)

where G₀ is that value that the normal stress φₙ is equal to zero, b₁, b₂ are constant coefficients, and dimensionless or in a dimension of 1/MPa, 1/kPa or 1/Pa.

For the dimensionless ξ, the softening factor evolution equation is:

ξ=ξ₀/(1+(ξ₀/ξ_{c}−1)(φₙ/φₙ^{c})^{c}) (7.6)

where ξ₀) is value when the normal stress (φₙ) is equal to zero, ξ_{c} is the value that φₙ is equal to φₙ^{c}, and ζ is a constant coefficient.

(7.3) Hardening Characteristic

When the normal stress of the geological material is higher than a critical normal stress φₙ^{crit}, there is no obvious peak stress, so two calculation methods can be invented.

(7.3.1) First Calculation Method

The first calculation method includes following steps:

Substituting ξ=−1 and q=1 into the constitutive Equation(7.1), to obtain a′=1/(Ga′) and b′=1/(Gp), and the equation form is identical with the Duncan-Chang model and only describes perfect elasto-plastic hardening behavior characteristics of the material;

$$τ = \frac{γ}{{a}^{′} + {b}^{′} γ} \qquad ( 7.7 )$$

where a′, b′, a″ are constant coefficients;
where a condition of stress at peak, the Equation (7.7) becomes:

$${a}^{′} + {b}^{′} {γ}_{peak} = \frac{1}{{τ}_{peak} / {γ}_{peak}} \qquad ( 7.8 )$$

Defining a secant modulus

$$\begin{matrix}{k}_{scant} = \frac{{τ}_{peak}}{{γ}_{peak}} and & ( 7.9 ) \\ {a}^{′} + {b}^{′} {γ}_{peak} = \frac{1}{{K}_{cant}} & ( 7.10 )\end{matrix}$$

Finding derivative of Equation (7.7), the corresponding derivative is a tangent modulus, and under any stress status condition, the tangent modulus G₁ is expressed as:

$${G}_{i} = \frac{{a}^{′}}{{( {a}^{′} + {b}^{′} γ )}^{2}} \qquad ( 7.11 )$$

Applying the Equation (7.11) to obtain the tangent modulus G₁ under the maximum stress:

G₁=a′K_{cant}² (7.12)

As we all know, the conventional experiment is hard to obtain the peak stress for a plastic hardening behavior without obvious peak stress, the selection of the peak stress must satisfy various stress criteria (such as Mohr-Coulomb Criteria), and the corresponding shear strain also satisfies the strain equation provided by the present invention. Under the condition of the stress at peak, researching the tangent modulus G₁ of the curve of the experiment, and assuming that the tangent modulus G₁ has characteristics below:

G₁=α(φₙ−φₙ^{crit})(φₙ/φₙ^{crit})^{k}^{ₙ} (7.13)

φₙ^{crit}≦φₙ≦φₙ ^{max}, and α, kₙ are constant coefficients;

The Equation (7.13) has Features Below.

When φₙ=φₙ^{crit}, the tangent modulus is equal to zero and the curve shows characteristics of approximately perfect elasto-plastic model; when φₙ reaches a constant value φₙ^{max}, the curve shows linear characteristics theoretically, the normal stress is determined by the experiment, φₙ=φₙ^{max} and corresponding tangent modulus is G^{max}, and the equation is expressed as:

α(φₙ^{max}−φₙ^{max})(φₙ^{max}/φₙ^{crit})^{k}^{ₙ}G^{max} (7.14)

In a range of the normal stress (φₙ^{crit}, φₙ^{max}], selecting a normal stress φₙ^{a} and performing an experiment to determine a corresponding tangent modulus G^{a}, to obtain the equation below:

α(φₙ^{a}−φₙ^{crit})(φₙ^{a}/φₙ^{crit})^{k}^{ₙ}=G^{a} (7.15)

Determining Constant Coefficients by Equations (7.14 and 7.15):

$${k}_{n} = \frac{ln ( {G}^{max} ( {σ}_{n}^{α} - {σ}_{n}^{crit} ) / ( {G}^{a} ( {σ}_{n}^{max} - {σ}_{n}^{crit} ) )}{ln ( {σ}_{n}^{max} / {σ}_{n}^{α} )} and α = {G}^{max} / ( ( {σ}_{n}^{max} - {σ}_{n}^{crit} ) {( {σ}_{n}^{max} / {σ}_{n}^{crit} )}^{{k}_{n}} ) \qquad ( 7.16 )$$

After the tangent modulus Gₜ of the peak stress under a condition of a specific normal stress is determined, a′ is determined by Equation (7.12) and b′ is determined by the Equation (7.10), so as to determine all parameters of a new Duncan-Chang model.

(7.3.2)Second Calculation Method

The second calculation method includes following steps:

Substituting ξ=−1 into the constitutive Equation (7.1) to express the Equation (7.17):

$$τ = \frac{G γ}{1 + {γ}^{q} / p} \qquad ( 7.17 )$$

under the peak stress:

$$\begin{matrix}{τ}^{peak} / {γ}_{peak} = \frac{G}{1 + {( {γ}_{peak} )}^{q} / p} & ( 7.18 ) \\ {γ}_{peak}^{q} / p = \frac{G}{{K}_{scant}} - 1 & ( 7.19 )\end{matrix}$$

Similarly, finding derivative of the Equation (7.17), wherein the obtained derivative is a tangent modulus:

$$\frac{\partial τ}{\partial γ} = \frac{G}{( 1 + {γ}^{q} / p )} - \frac{Gq {γ}^{q} / p}{{( 1 + {γ}^{q} / p )}^{2}} \qquad ( 7.20 )$$

When the peak stress satisfies the current Mohr-Coulomb Criteria, the peak strain also satisfies the Equation (7.4), and the tangent modulus is Gₜ under the peak stress.

According to Equations (7.18 and 7.19), under the peak stress, the tangent modulus satisfies an Equation (7.21):

$${G}_{t} = {K}_{scant} [ 1 + \frac{{qK}_{scant}}{G} ( 1 - \frac{G}{{K}_{scant}} ) ] \qquad ( 7.21 )$$

Solving the tangent modulus corresponding to the peak stress according to the Equation (7.13), solving parameter q according to the Equation (7.21), and solving parameter P according to the Equation (7.19).

(8) For the slice method widely applied, the determination of the potential sliding surface by the failure angle rotation method includes following sub-steps:

(8.1) Conducting a compartment division on the slope;

(8.2) Calculating a vertical stress by product of a gravity and a height, and calculating a horizontal stress and shear stress by vector components of an unbalance thrust in horizontal and a shear stress from the vertical to the horizontal direction, wherein it is assumed that the vector component in horizontal direction and the vector component in the direction vertical to the horizontal direction satisfy a specific stress distribution condition (such as linear distribution or parabolic curve distribution);

(8.3) Calculating a friction stress on a bottom of a compartment according to the step (7).

(9) The conditions of determination of the potential sliding surface are divided into two cases for numerical calculation:

(9.1) Numerical Calculation

The potential sliding surface is determined by the numerical calculation, and the determination is conducted by stepwise applying the conventional strength reduction method and the possible-load (or displacement) boundary condition method.

(9.1.1) Conventional Strength Reduction Method

Based on the failure angle rotation method provided by the present invention, the critical anti-shearing strength is reduced until the failure compartment located on a free surface is situated in a limit equilibrium state.

(9.1.2) Load (or Displacement) Boundary Condition Method

Based on the failure angle rotation method of the present invention, the corresponding load or displacement boundary condition is applied on the possible failure until the failure compartment located on a free surface is situated in a limit equilibrium state.

(9.2) Slice Method

The determination of the potential sliding surface by the slice method is conducted by conventional strength reduction and the load (or displacement) boundary condition method.

(9.2.1) Conventional Strength Reduction Method

Based on the failure angle rotation method of the present invention, the critical anti-shearing strength on the bottom of the compartment is reduced until the failure compartment located on a free surface is situated in a limit equilibrium state.

(9.2.2) Load (or Displacement) Boundary g Condition Method

Based on the failure angle rotation method of the present invention, the corresponding load or displacement boundary condition is applied on the possible failure until the failure compartment located on a free surface is situated in a limit equilibrium state.

In the two methods, calculation of the strength reduction method does not have physical meaning, so the obtained stress and displacement by calculation of the strength reduction method cannot be compared with that in situ, logically.

The above-mentioned descriptions represent merely the exemplary embodiment of the present disclosure, without any intention to limit the scope of the present disclosure thereto. Various equivalent changes, alternations or modifications based on the claims of present disclosure are all consequently viewed as being embraced by the scope of the present disclosure.

What is claimed is:

1. A method of calculating potential sliding surface of progressive failure of slope, comprising steps of:
(1) performing an shear stress-shear strain complete process curve experiment for the geological material of slope, to obtain a peak stress, a peak strain and a complete process curve;
(2) determining a cohesion C and a sliding-surface friction angle value φ by the peak stress, determining magnitudes of constant coefficients a₁, a₂, a₃ by the peak strain, and determining a shear modulus G, a critical normal stress φₙ^{crit} and constant coefficients ξ, α, kₙ by variation curve characteristics;
(3) establishing a numerical calculation model with consideration of shear failure distribution and tension failure distribution area;
(4) based on numerical calculation of a strain softening constitutive model, calculating failure ratio, failure percentage and failure area percentage at different points and entire sliding face of the current slope, so as to provide different possible failure paths by a combination manner;
(5) for each of critical state elements of the slope, according to an angle between a shear stress surface of unit failure and the minimum principal stress being 45°+φ/2, calculating a rotating angle δ of the maximum principal stress with respect to a vertical direction, to determine a rotating angle βᵢᵢ=45°φ/2−φₙ of the sliding surface with respect to a horizontal surface, wherein the rotating angle δ is calculated by a two-dimensional Equation tan 2δ=−2τ_{xy}/(φₓₓ−φ_{yy}) or by a three-dimensional Equation tan 2δₓₓ=−2τ_{xy}/(φₓₓ−φ_{yy}), tan 2δ_{yy}=−2τ_{zy}/(φ_{yy}−φ_{zz}), and tan 2δ_{zz}=−2τ_{zx}/(φ_{zz}−φₓₓ);
(6) as to possibly applied load or displacement boundary condition, stepwise applying corresponding to boundary condition and searching possible failure mode under different boundary conditions, and performing potential sliding surface rotating angle continuation and calculating a stability factor of the corresponding slope, to determine the potential sliding surface.

2. The method according to claim 1, wherein the sliding surface shear stress-shear strain with softening and hardening mechanical characteristics is employed preferably:
(7.1) shear stress-shear strain equation shear stress-shear strain complying with a four-parameter constitutive equation:
τ=Gγ[1+γ^{q}/p]^{ξ} (7.1)
where τ, γ are shear stress and shear strain respectively, G is shear modulus, p, q, ξ are constant coefficients under different normal stresses, and τ, G in a unit of MPa, kPa or Pa, p, q, ξ are parameters with no unit;
wherein the softening and hardening behaviors are described by:
(7.2) softening characteristics as to the material behavior with having softening characteristic, −1<ξ≦0 and 1+qξ≠0;
wherein the critical strain space satisfies a relation:
P(1+qξ)γ^{q}ₚₑₐₖ=0 (7.2)
wherein γₚₑₐₖ is the strain corresponding to the critical stress;
wherein it is assumed that the critical stress space τₚₑₐₖ satisfies the Mohr-Coulomb Criteria:
τₚₑₐₖ=C+φₙ tan φ (7.3)
where C is cohesion, φₙ is normal stress, C and φₙ are in a unit of MPa, kPa or Pa, φ is sliding-surface friction angle;
wherein it is assumed that the critical strain space is only correlated with the normal stress, and the critical strain γₚₑₐₖ has a relation:
(γₚₑₐₖ/a₃)²+((φₙ−a₂)/a₁)^{ξN}=1 (7.4.1)
or γₚₑₐₖ²=a₁⁰+a₂⁰φₙ+a₃⁰φₙ² (7.4.2)
wherein a₁, a₂, a₃, ζ_{N}, a₁⁰, a₂⁰, a₃⁰ are constant coefficients, a₁, a₂ are in the unit of MPa, kPa or Pa, a₃, ζ_{N} are dimensionless coefficients, or a₂⁰, a₃⁰ are in a dimension of 1/MPa, 1/MPa², 1/kPa, 1/kPa² or 1/Pa, 1/Pa²;
and G=G₀+b₁φₙ+b₂φₙ² (7.5)
wherein G₀ is that value that the normal stress φₙ is equal to zero, b₁, b₂ are constant coefficients, and dimensionless or in a dimension of 1/MPa, 1/kPa or 1/Pa;
wherein for the dimensionless ξ, the softening factor evolution equation is expressed as:
ξ=ξ₀/(1+(ξ₀/ξ_{c}−1)(φₙ/φₙ^{c})^{ζ}) (7.6)
wherein ξ₀ is the value when the normal stress (φₙ) is equal to zero, ξ_{c} is the value that φₙ is equal to φₙ^{c}, and ζ is a constant coefficient;
(7.3) hardening characteristic
wherein when the normal stress of the geological material is higher than a critical normal stress φₙ^{crit}, no obvious peak stress exists and two calculation methods are invented:
(7.3.1) first calculation method the first calculation method comprising steps of:
substituting ξ=−1 and q=1 into the constitutive Equation(7.1), to obtain a′=1/(Ga″) and b′=1/(Gp), wherein the equation form is identical with the Duncan-Chang model and only describes elastic-plastic hardening behavior characteristics of the material;
$$τ = \frac{γ}{{a}^{′} + {b}^{′} γ} \qquad ( 7.7 )$$
where a′ [symbol] b′, a″ are constant coefficients;
wherein under a condition of the stress at peak, the Equation (7.7) becomes
$${a}^{′} + {b}^{′} {γ}_{peak} = \frac{1}{{τ}_{peak} / {γ}_{peak}} \qquad ( 7.8 )$$
a secant modulus is defined as
$$\begin{matrix}{k}_{scant} = \frac{{τ}_{peak}}{{γ}_{peak}} and & ( 7.9 ) \\ {a}^{′} + {b}^{′} {γ}_{peak} = \frac{1}{{K}_{cant}} & ( 7.10 )\end{matrix}$$
finding derivative of Equation (7.7),wherein the corresponding derivative is a tangent modulus, and under any stress state condition, the tangent modulus Gᵢ is expressed as:
$${G}_{i} = \frac{{a}^{′}}{{( {a}^{′} + {b}^{′} γ )}^{2}} \qquad ( 7.11 )$$
applying the Equation (7.11) to obtain the tangent modulus Gₜ under the maximum stress:
Gᵢ=a′K_{cant}² (7.12)
under the condition of the stress at peak, researching the tangent modulus Gₜ of the curve of the experiment, and assuming that the tangent modulus Gₜ has characteristics below:
Gₜ=α(φₙ−φₙ ^{crit})(φₙ/φₙ^{crit})^{k}^{ₙ} (7.13)
φₙ^{crit}≦φₙ≦φₙ^{max}, wherein α, kₙ are constant coefficients;
wherein the Equation (7.13) has features below:
wherein when φₙ=φₙ^{crit}, the tangent modulus is equal to zero and the curve shows characteristics of approximately perfect elasto-plastic model;
wherein when φₙ reaches a constant value φₙ^{max}, the curve shows linear characteristics and the theoretically the normal stress is determined by the experiment, φₙ=φₙ^{max} and corresponding tangent modulus is G^{max}, and an equation is expressed as:
α(φₙ^{max}−φₙ^{crit})(φₙ^{max}/φₙ^{crit})^{k}^{ₙ}G^{max} (7.14)
in a range of the normal stress(φₙ^{crit}, φₙ^{max}], selecting a normal stress φₙ^{a} and performing an experiment to determine a corresponding tangent modulus G^{a}, to obtain the equation below:
α(φₙ^{a}−φₙ^{crit})(φₙ^{a}/φₙ^{crit})^{k}^{ₙ}G^{a} (7.15)
determining constant coefficients by Equations (7.14 and 7.15):
$${k}_{n} = \frac{ln ( {G}^{max} ( {σ}_{n}^{α} - {σ}_{n}^{crit} ) / ( {G}^{a} ( {σ}_{n}^{max} - {σ}_{n}^{crit} ) )}{ln ( {σ}_{n}^{max} / {σ}_{n}^{α} )} and α = {G}^{max} / ( ( {σ}_{n}^{max} - {σ}_{n}^{crit} ) {( {σ}_{n}^{max} / {σ}_{n}^{crit} )}^{{k}_{n}} ) \qquad ( 7.16 )$$
wherein after the tangent modulus Gₜ of the peak stress under a condition of a specific normal stress is determined, α′ is determined by Equation (7.12) and b′ is determined by the Equation (7.10), so as to determine all parameters of a new Duncan-Chang model;
(7.3.2) second calculation method
the second calculation method comprising steps of:
substituting ξ=−1 into the constitutive Equation (7.1) to express the Equation (7.17):
$$τ = \frac{G γ}{1 + {γ}^{q} / p} \qquad ( 7.17 )$$
under the peak stress:
$$\begin{matrix}{τ}^{peak} / {γ}_{peak} = \frac{G}{1 + {( {γ}_{peak} )}^{q} / p} & ( 7.18 ) \\ {γ}_{peak}^{q} / p = \frac{G}{{K}_{scant}} - 1 & ( 7.19 )\end{matrix}$$
finding derivative of the Equation (7.17), wherein the obtained derivative is a tangent modulus:
$$\frac{\partial τ}{\partial γ} = \frac{G}{( 1 + {γ}^{q} / p )} - \frac{Gq {γ}^{q} / p}{{( 1 + {γ}^{q} / p )}^{2}} \qquad ( 7.20 )$$
wherein when the peak stress satisfies the current Mohr-Coulomb Criteria, the peak strain also satisfies the Equation (7.4), and the tangent modulus is Gₜ under the peak stress;
wherein according to Equations (7.18 and 7.19), under the peak stress, the tangent modulus satisfies an Equation (7.21):
$${G}_{t} = {K}_{scant} [ 1 + \frac{{qK}_{scant}}{G} ( 1 - \frac{G}{{K}_{scant}} ) ] \qquad ( 7.21 )$$
solving the tangent modulus corresponding to the peak stress according to the Equation (7.13), solving parameter q according to the Equation (7.21), and solving parameter p according to the Equation (7.19).

3. The method according to claim 2, while applying to a slice method, the method of calculating the potential sliding surface further comprising sub-steps:
(1) conducting a compartment division on the slope;
(2) calculating a vertical stress by product of a gravity and a height, and calculating a horizontal stress and shear stress by vector components of an unbalance thrust in horizontal direction and a shear stress from the direction vertical to the horizontal direction, wherein it is assumed that the vector component in horizontal direction and the vector component in the direction vertical to the horizontal direction satisfy a specific stress distribution condition; and
3) calculating a friction stress on a bottom of a compartment.

4. The method according to claim 3, further comprising a sub-step of conducting the strength reduction to determine the potential sliding surface of the slice method, wherein the critical anti-shearing strength on the bottom of the compartment is reduced until the failure compartment located on a free surface is situated in a limit equilibrium state.

5. The method according to claim 3, further comprising a sub-step of conducting the determination of the potential sliding surface of the slice method according to the applied load or displacement boundary condition, wherein the corresponding load or displacement boundary condition is applied on the possible failure until the failure compartment located on a free surface is situated in a limit equilibrium state.
